(19) United States
(12) Patent Application Publication
(10) Pub. No.: US 2007/0166673 A1
(43) Pub. Date: Jul. 19, 2007

(54) Abacus

(76) Inventor: Shlomo Ruvane Frieman, Los Angeles, CA (US)

Correspondence Address: Shlomo R. Frieman, 139 South Mansfield Avenue, Los Angeles, CA, 90036-3018, US

(21) Appl. No.: 11/331,949

(22) Filed: Jan. 13, 2006

(51) Int. Cl. G09B 19/02

(52) U.S. Cl. 434/203

(57) ABSTRACT

An abacus for assisting in teaching the place value, addition (including carrying), and subtraction, (including borrowing) comprises (a) a least 2 substantially parallel bars; (b) at least 18 beads mounted and independently moveable along the axis of each of the substantially parallel bars; and (c) means for maintaining each of the substantially parallel bars in a substantially fixed position with respect to each other. Preferably, the different groups of beads located on the various parallel bars are coded with some form of indicia (such as color) to denote their respective place in the 3-member sequence (i.e., ones, tens, and hundreds) of the base 10 numbering system.

### SEQUENCE LISTING

Not Applicable

### DESCRIPTION OF RELATED ART

The abacus (or soroban in Japanese or suan pan in Chinese) is an ancient mathematical instrument used for calculation. The abacus is one of the world's first real calculating tools—and early forms of an abacus are nearly 2500 years old. The modern Chinese suan pan has been in use since about the 14th century. The Japanese soroban has been in use since at least the 16th century. Originally, the Japanese soroban looked much like the Chinese suan pan (5 beads below a reckoning bar, 2 beads above the reckoning bar) but it was simplified around 1850 and reduced to a single bead above the reckoning bar (or beam) and later in 1930 to just 4 beads below the reckoning bar. Both the Japanese soroban and the Chinese suan pan employ monochromatic beads. During use, the Japanese soroban and the Chinese suan pan are positioned so that the beads move along their respective bars towards and away from (as opposed to the right and left of) the user.

Tomoe Soroban Co., Ltd. has recently introduced a truncated Japanese soroban (which Tomoe calls a Pacchi soroban) that has only three bars, with the beads in the first column (that denotes ones) having a first color, the beads in the second column (that denotes tens) having a second color, and the beads in the third column (that denotes hundreds) having a third color. The Pacchi soroban is intended for the small children, about 3-5 years old.

Other than the Pacchi soroban, other children's abacuses known to the inventor have only 10 bars, contain 10 beads per column, and use polychromatic beads in a five-member pattern. More specifically, in these 10-column children's abacuses the beads in the first column have a first color (e.g., red), the beads in the second column have a second color (e.g., orange), the beads in the third column have a third color (e.g., yellow), the beads in the fourth column have a fourth color (e.g., green), the beads in the fifth column have a fifth color (e.g., blue), the beads in the sixth column have the first color, the beads in the seventh column have the second color, the beads in the eighth column have the third color, the beads in the ninth column have the fourth color, and the beads in the tenth column have the fifth color. Also, unlike the Japanese soroban (including the Pacchi soroban) and the Chinese suan pan the, the 10-column children's abacuses do not contain a reckoning bar and, during use, are positioned so that the beads move along their respective bars to the right and left of (as opposed to towards and away from) the user.

In addition, numerous teaching aids exist that are intended to help children learn the fundamental math concepts of place value, addition (including carrying), and subtraction (including borrowing). See, for example, www.lakeshoreleaming.com. These teachings aids have many drawbacks. One drawback is that they tend to contain tens, if not hundreds of separate pieces or parts. For example, Lakeshore's Days in School Math Activity Center (Lakeshore catalog item LM905), which is intended to introduce and reinforce the concept of place value in a way children can really relate to, comes with 200 wooden rods and over 40 cloth tiles. Similarly, Lakeshore's Place Value Activity Kit (Lakeshore catalog item LC165), which targets standards in the areas of (1) place value to thousands, (2) using concrete objects to solve problems, and (3) regrouping, comes with 100 unit cubes, ten 10-unit rods, ten 100-unit flats and one 1,000-unit cube. Because of their many pieces, teaching aids often require much set up and clean up time and their pieces are prone to getting lost or misplaced. Furthermore, also due to their many pieces, current teaching aids that address regrouping require many time consuming, repetitive, and boring manipulations to perform regrouping. Moreover, these current teaching aids often present regrouping as a separate concept and fail to show either (1) its connection or relationship to addition and/or subtraction or (2) how to regroup during actual addition and/or subtraction operations.

Another drawback of these teaching aids it that they tend to be directed either (1) to place value or (2) to basic operations that include addition and subtraction. Therefore, separate teaching aids are required to cover these different subjects—resulting in a budget problem for the school and a storage space problem for the classroom.

### BRIEF SUMMARY OF THE INVENTION

Accordingly, there is a need for a teaching aid that (a) contains just a few separate pieces or parts, (b) covers the math concepts of place value, addition, and subtraction, (c) is capable of having students perform regrouping quickly and easily, and (d) clearly shows students how regrouping is connected and related to addition and subtraction and enables students to regroup when necessary during actual addition and subtraction operations.

The abacuses of the present invention solve the above need because (a) they comprise just one integrated piece (and at most two separate pieces), (b) can be used as an aid for teaching the math concepts of place value, addition, and subtraction, and (c) they enable students to quickly and easily perform regrouping (d) while adding and subtracting. More specifically, in one embodiment of the present invention, the abacus comprises (a) at least two (and preferably at least three) substantially parallel bars; (b) at least 18 (and preferably exactly 18) beads mounted and independently moveable along the axis of each of the substantially parallel bars; and (c) a frame or other means for maintaining each of the substantially parallel bars in a substantially fixed position with respect to each other. Each bead located on any of the parallel bars of the abacus of the present invention is worth 10 times the value of any bead located on the parallel bar to its immediate right. Accordingly, regrouping can readily be performed by two simple flicks of a finger. For instance, in the case of addition (for example, when adding 15+8), when the number of beads added on any bar or column exceeds 10 (e.g., 5+8 in the present example), 10 beads in that column can be moved up with a flick of a finger and one bead on the column to the immediate left (which corresponds to the same numerical value as the 10 beads that were moved up on the column to the immediate right) can be brought down by a second flick of a finger. Likewise; in the case of subtraction (for example, when subtracting 15−8), when the number of beads needed to be subtracted from the beads on any column exceeds the number of beads currently available on that column (e.g., 5−8 in the present example), a bead on the column to the immediately left can be flicked up and 10 beads on that column (which correspond to the same numerical value as the 1 bead that was moved up on the column to the immediate left) can be brought down by a second flick of the finger.

In addition, to help students visually perceive and mentally understand place value and the repeating nature of the base 10 number system, namely, how the place value progresses in a three-member pattern as it advances from

| | | | | | |
|---|---|---|---|---|---|
| ones | to | 10's | to | 100's | to |
| thousands | to | 10 thousands | to | 100 thousands | to |
| millions | to | 10 millions | to | 100 millions, etc., | |

the beads representing the first member of the three-member repeating pattern (namely, ones, thousands, millions, etc.) are preferably marked with a first indicia (such as a first color), the beads representing the second member of the three-member repeating pattern (namely, tens, ten thousands, ten millions, etc.) are preferably marked with a second indicia (such as a second color), and the beads representing the third member of the three-member repeating pattern (namely, hundreds, hundred thousands, hundred millions, etc.) are preferably marked with a third indicia (such as a third color). For example, an abacus within the scope of the present invention that comprises 9 substantially parallel bars can be used to explain place value ranging from ones to hundreds of millions. In this version of the abacus, the beads that are mounted and independently moveable along the axis of the first, fourth, and seventh of the substantially parallel bars have substantially the same first color (e.g., red); the beads that are mounted and independently moveable along the axis of the second, fifth, and eighth of the substantially parallel bars have substantially the same second color (e.g., white); and the beads that are mounted and independently moveable along the axis of the third, sixth, and ninth of the substantially parallel bars have substantially the same third color (e.g., blue). If the abacus were to comprise more that 9 substantially parallel bars, (i) the three-member color sequence (e.g., red, white, and blue in the foregoing example) would repeated for the additional groups of beads mounted and independently moveable along the axis of the additional, substantially parallel bars and (ii) the abacus could be used to explain an even wider range of place values.

The abacus of the present invention can exist in different forms. For example, the abacus can be a handheld, tangible object or a virtual object that is viewed on a computer, television, liquid crystal, or plasma screen or display or on any other means capable of displaying virtual images.

The abacus of the present invention can also be one component of a learning aid kit that further comprises a ruler or other means for measuring at least a portion of the beads mounted along the axis of any one of the substantially parallel bars. For example, a ruler can be divided into tens units, with the height of each unit being substantially equal to the height of an individual bead.

In an alternative embodiment of the present invention, the abacus is a soroban, a saun pan, or any other conventional abacus where the beads are coded in the manner discussed above to represent the three-member repeating pattern of the base 10 number system.

The accompanying drawings and following detailed description are intended to provide a fuller understanding of the nature and advantages of the abacuses of the present invention.

### BRIEF DESCRIPTION OF THE SEVERAL VIEWS OF THE DRAWINGS

Abacuses within the scope of the present invention are shown in the drawings where the same numbers represent the same element and where:

FIG. 1 is a perspective view of an abacus within the scope of the present invention;

FIG. 2 is a perspective view of a ruler capable of being used to measure a desired number of beads to be moved on any given bar of the abacus shown in FIG. 1;

FIG. 3 is a perspective view of a saun pan having color coded beads in accordance with the present invention; and

FIG. 4 is a perspective view of a soroban having color-coded beads in accordance with the present invention.

### DETAILED DESCRIPTION OF THE INVENTION

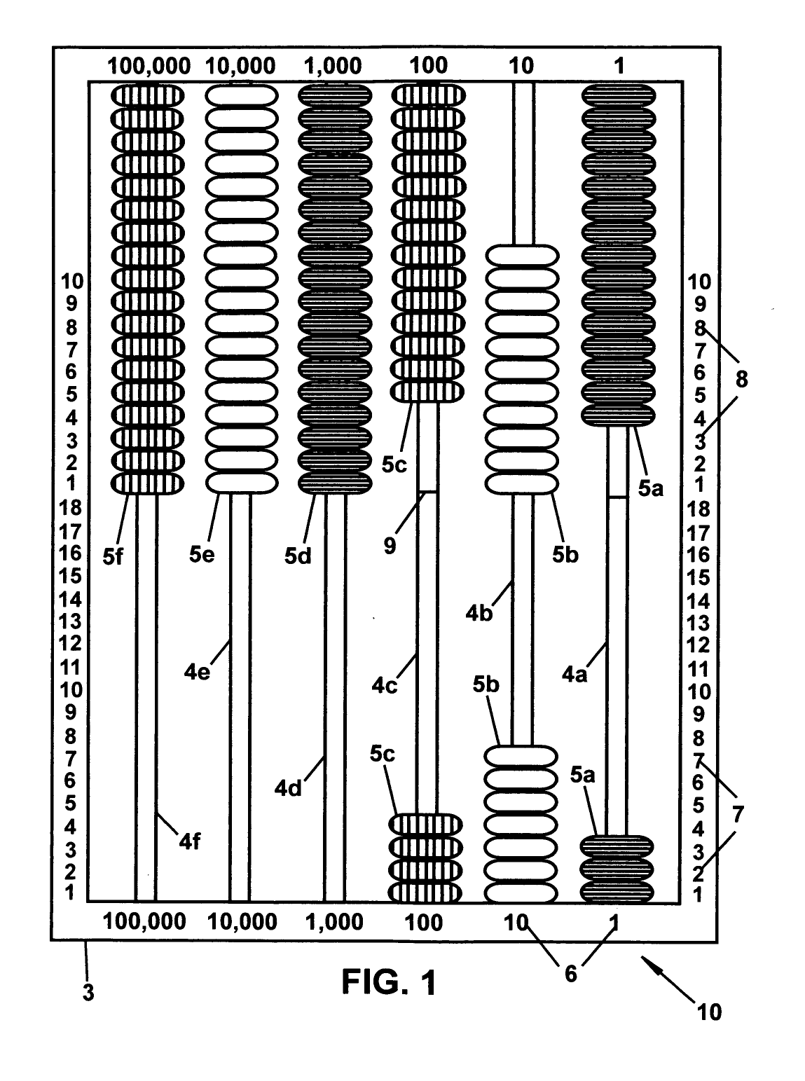

In the embodiment of the invention shown in FIG. 1, the abacus 10 comprises a frame 3 that holds six bars or columns or rods 4a-4f. Each of the bars 4a-4f is immobilized in the frame 3 by being sunk into depressions or holes (not shown) in the frame 3. Alternatively, each of the bars 4a-4f can be attached to the frame 3 by nails, screws, welds, glue, or any other means for attaching one object to another.

On each of bars 4a-4f is mounted or positioned a group comprising at least 18 independently, axially slideable beads 5a-5f, respectively. The reason that each group comprises at least 18 beads 5a-5f is because, in a based 10 numbering system, 9 is the maximum number that can be present at any place value position. Accordingly, when two numbers having the number 9 at the same place value position (e.g., 394 plus 194) are added, the sum obtained for that place value position is 18. Since 18=8+10, 8 will occupy the place value position of the numbers being added and the remaining 10 will be carried or regrouped and placed in the place value position located to the immediate left. To illustrate:

1 [symbol] carried or regrouped

| | | | |
|---|---|---|---|
| 394 | 394 | 394 | 394 |
| 194 | 194 | 194 | 194 |
| | 8 | 88 | 588 |

Accordingly, a minimum of 18 beads 5a-5f per group is required for each functional column 4a-4f (as opposed to any decorative or merely structural column (not shown)) of the abacus 10 of the present invention. For the same reason, only 18 beads 5a-5f per group need be present on each functional column 4a-4f.

The abacus 10 preferably comprises one or more means to help identify the magnitude of each group of beads 5a-5f located on their respective bars 4a-4f or to count the number of beads 5a-5f either present at the bottom portion of any of the bars 4a-4f or required to be moved. For example, at the bottom and top of the frame 3 of the abacus 10 are preferably located a first set of numbers 6 that represent the order of magnitude of each of bars 4a-4f. For example, the six bars 4a-4f of the abacus 10 of FIG. 1 have the respective magnitudes (going from left to right) of 1, 10, 100, 1,000, 10,000, and 100,000.

In addition, on the left-and right-hand sides of the abacus 10 are preferably present a second set of numbers 7 that range from 1 through 18. The second number set 7 aids in counting any beads (such as beads 5aon column 4a, beads 5b on column 4b, and beads 5c on column 4c) located at the bottom portion of the abacus 10. To illustrate, as shown in FIG. 1, the beads 5a, 5b, and 5c that are respectively present at the bottom portion of one column 4a, ten column 4b, and hundred column 4c represent the number 473.

Also, it is preferred that a third set of numbers 8 ranging from 1 to 10 be located on the left-and right-hand sides of the frame 3 above the second number set 7. This third number set 8 helps to count the number of any beads 5a-5f that are to be moved to the lower portion of the abacus 10. For example, at the start of any math problem, all the beads 5a-5f should be initially located in the upper portion of the abacus 10. When so located, the bottom-most bead of any group of beads 5a-5f is located at the beginning of the range of the third number set 8. Accordingly, depending on the initial amount of beads to be moved, a person can simply look at the third number set 8 located on the right-or left-hand side of the frame 3 to quickly determine the location of all the beads required to be initially moved. After the initial amount of beads 5a-5f have been moved, any remaining beads 5a-5f can be moved to their respective reference line 9 as done with the remaining portion of beads 5b located on column 4b.

It is also preferred that the beads 5a-5f be coded with some form of indicia to denote their respective place in the 3-member sequence of the base 10 numbering system. For example, as shown in FIG. 1, the beads 5a, and 5d representing ones and thousands, respectively, have substantially the same first color blue, the beads 5b and 5e representing tens and ten thousands, respectively, have substantially the same second color white, and the beads 5c and 5f representing hundreds and hundred thousands, respectively, have substantially the same third color red. Alternatively (but not shown), beads representing ones, tens, and hundreds, can be coded using other indicia or marking systems such as systems based on either different patterns (e.g., the beads representing ones displaying dots, the beads representing tens displaying stripes, and the beads representing hundreds displaying diamonds), or different shapes (e.g., the beads representing ones being spherical-shaped, the beads representing tens being pyramid-shaped, and the beads representing hundreds being diamond-shaped), etc.

The abacus 10 contains a minimum of least two bars. Generally, the number of bars will range from 3 to 9. (Whenever a closed range of numbers is stated in the specification or claims, each number within the closed range should be considered as though it is specifically stated. For example, the above stated closed range of 3 to 9 should be considered as having explicitly stated the numbers 3, 4, 5, 6, 7, 8, and 9.) Because the abacus 10 is intended for use by children just learning place value, addition (including carrying), and subtraction (including borrowing), the abacus 10 preferably has just 3 or 4 bars (such as bars 4a-4c or 4a-4d, respectively).

Unlike the Japanese soroban (including the Pacchi soroban) and the Chinese suan pan, the abacus 10 of the present invention does not contain a reference bar. In fact, the presence of a reference that divides the beads on the bars into an upper group and a lower group would constitute a material change in the basic and novel characteristics of the abacus 10 of FIG. 1. Therefore, as used in the claims, the phrase “consisting essentially of” excludes the presence of a reference bar from the claimed abacus.

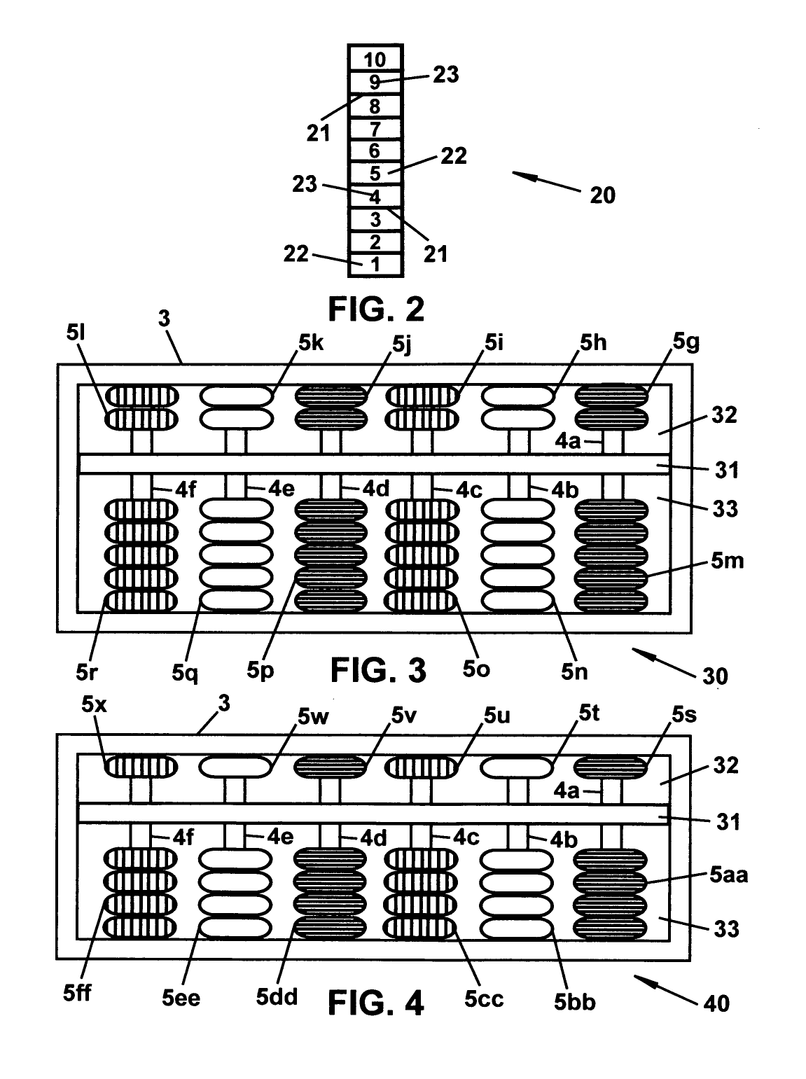

Optionally, a ruler 20 (such as shown in FIG. 2) can be used to count any of the beads 5a-5f needed to be added to or subtracted from any column 4a-4f. In the embodiment shown in FIG. 2, the ruler 20 is divided lengthwise into 10 substantially equal parts by lines 21. The length of each segment 22 is substantially equal to the height of the individual beads 5a-5f, with the segments 22 being sequentially numbered with numbers 23 from 1 to 10.

During use, the abacus 10 of the present invention should be positioned so that the beads 5a-5f move along their respective bars 4a-4f towards and away from (as opposed to the right and left of) the user.

The abacuses 10 of the present invention can be made by techniques well know to those skilled in the art (e.g., injection molding, forged or cast metal, carpentry, etc.) using plastic, metal, and/or wood. Due to their length, the bars 4a-4f should be preferably made from a very sturdy material such as stainless steel.

While the preferred embodiments of the invention have been described above in detail, some modifications can be made without departing from the spirit of the present invention. For example, in a modified embodiment of the present invention, the beads of a prior art abacus are coded with some form of indicia to denote their respective place in the three-member sequence of the base 10 numbering system. For example, as illustrated in FIGS. 3 and 4, respectively, a modified saun pan 30 and a modified soroban 40 within this alternative embodiment of the present invention comprise a frame 3, a horizontal reference bar 31, and a plurality of vertical bars 4a-4f. The modified saun pan 30 shown in FIG. 3 further comprises two beads 5g-5l located above the reference bar 31 in the upper field 32 and slideably mounted on each of the vertical bars 4a-4f, respectively, and five beads 5m-5r located below the refe lower field 33 and slideably mounted on the vertical bars 4a-4f, respectively, while the modified soroban 40 shown in FIG. 4 has one bead 5s-5x located above the reference bar 31 in the upper field 32 and slideably mounted on each of the vertical bars 4a-4f, respectively, and four beads 5aa-5ff located below the reference bar 31 in the lower field 33 and slideably mounted on the vertical bars 4a-4f, respectively. Like those of the prior art, the number of vertical bars 4a-4f present in the saun pan 30 and the soroban 40 can vary, with the number of vertical bars 4a-4f on the saun pan 30 usually ranging from 6 to 21, more typically from 9 to 18, and the number of vertical bars 4a-4f present in the soroban 40 usually ranging from 12 to 30, more typically from 15 to 27.

Like the beads 5a-5f of the abacus 10 of FIG. 1, the beads 5g-5r of the saun pan 30 of FIG. 3 and the beads 5s-5x and 5aa-5ff of the soroban 40 of FIG. 4 are also coded with some form of indicia (e.g., color, shape, pattern, etc.) to denote their respective place in the three-member sequence of the base 10 numbering system. For example, in the saun pan 30 of FIG. 3, the beads (i) 5g and 5m and (ii) 5j and 5p representing ones and thousands, respectively, have substantially the same first color blue, the beads (iii) 5h and 5n and (iv) 5k and 5q representing tens and ten thousands, respectively, have substantially the same second color white, and the beads (v) 5i and 5o and (vi) 5l and 5r representing hundreds and hundred thousands, respectively, have substantially the same third color red. Similarly, in the soroban 40 of FIG. 4, the beads (i) 5s and 5aa and (ii) 5v and 5dd representing ones and thousands, respectively, have substantially the same first color blue, the beads (iii) 5t and 5bb and (iv) 5w and 5ee representing tens and ten thousands, respectively, have substantially the same second color white, and the beads (v) 5u and 5cc and (vi) 5x and 5ff representing hundreds and hundred thousands, respectively, have substantially the same third color red.

In another alternative embodiment of the present invention, both interactive and non-interactive software programs can be written by those skilled in the art so that virtual images of the abacuses of the present invention can be displayed on a monitor of any suitably programmable electrical apparatus (such as a television screen, computer screen, liquid crystal display, etc.).

Accordingly, the foregoing alternative embodiments are included within the scope of the present invention.

1. An abacus comprising:
(a) a least 2 substantially parallel bars;
(b) at least 18 beads mounted and independently moveable along the axis of each of the substantially parallel bars; and
(c) means for maintaining each of the substantially parallel bars in a substantially fixed position with respect to each other.

2. The abacus of claim 1 comprising 2 substantially parallel bars and where
18 beads are mounted and independently moveable along the axis of the first of the 2 substantially parallel bars; and
18 beads are mounted and independently moveable along the axis of the second of the 2 substantially parallel bars.

3. The abacus of claim 1 comprising at least 3 substantially parallel bars.

4. The abacus of claim 1 comprising 3 substantially parallel bars and where
18 beads are mounted and independently moveable along the axis of the first of the 3 substantially parallel bars;
18 beads are mounted and independently moveable along the axis of the second of the 3 substantially parallel bars; and
18 beads are mounted and independently moveable along the axis of the third of the 3 substantially parallel bars.

5-6. (canceled)

7. The abacus of claim 1 comprising at least 4 substantially parallel bars and where 18 beads are mounted and independently moveable along the axis of each of the substantially parallel bars.

8-9. (canceled)

10. The abacus of claim 1 comprising at least 6 substantially parallel bars and where 18 beads are mounted and independently moveable along the axis of each of the substantially parallel bars.

11-14. (canceled)

15. The abacus of claim 1 where the abacus is a virtual abacus displayed on means for displaying virtual images.

16. The abacus of claim 15 where the means for displaying virtual images is selected from the group consisting of computer screens, a television screens, liquid crystal display screens, and plasma screens.

17-20. (canceled)

21. An abacus comprising:
(a) a frame;
(b) from 2 through 9 bars with one end of each of the bars being affixed to one end of the frame, the other end of each of the bars being affixed to the opposing end of the frame, and with each of the affixed bars being substantially parallel to each other; and
(c) 18 beads mounted and independently moveable along the axis of each of the affixed, substantially parallel bars.

22. The abacus of claim 21 comprising from 2through 6 bars.

23. The abacus of claim 21 comprising 3 bars, where
18 beads are mounted and independently moveable along the axis of the first of the 3 affixed, substantially parallel bars;
18 beads are mounted and independently moveable along the axis of the second of the 3 affixed, substantially parallel bars; and
18 beads are mounted and independently moveable along the axis of the third of the 3 affixed, substantially parallel bars.

24. An abacus consisting of:
(a) a frame;
(b) from 2 through 9 bars with one end of each of the bars being affixed to one end of the frame, the other end of each of the bars being affixed to the opposing end of the frame, and with each of the affixed bars being substantially parallel to each other; and
(c) at least 18 beads mounted and independently moveable along the axis of each of the affixed, substantially parallel bars.

25. The abacus of claim 24 consisting of:
(a) the frame;
(b) from 2 through 6 bars; and
(c) 18 beads mounted and independently moveable along the axis of each of the affixed, substantially parallel bars.

26. The abacus of claim 24 consisting of:
(a) the frame;
(b) 3 bars;
(c) 18 beads mounted and independently moveable along the axis of the first of the 3 affixed, substantially parallel bars;
(d) 18 beads mounted and independently moveable along the axis of the second of the 3 affixed, substantially parallel bars; and
(e) 18 beads mounted and independently moveable along the axis of the third of the 3 affixed, substantially parallel bars.

27. The abacus of claim 21 comprising 4 bars, where
18 beads are mounted on, and independently moveable along the axis of, the first of the 4 affixed, substantially parallel bars;
18 beads are mounted on, and independently moveable along the axis of, the second of the 4 affixed, substantially parallel bars;
18 beads are mounted on, and independently moveable along the axis of, the third of the 4 affixed, substantially parallel bars; and
18 beads are mounted on, and independently moveable along the axis of, the fourth of the 4 affixed, substantially parallel bars.

28. The abacus of claim 21 comprising 5 bars, where
18 beads are mounted on, and independently moveable along the axis of, the first of the 5 affixed, substantially parallel bars;
18 beads are mounted on, and independently moveable along the axis of, the second of the 5 affixed, substantially parallel bars;
18 beads are mounted on, and independently moveable along the axis of, the third of the 5 affixed, substantially parallel bars;
18 beads are mounted on, and independently moveable along the axis of, the fourth of the 5 affixed, substantially parallel bars; and
18 beads are mounted on, and independently moveable along the axis of, the fifth of the 5 affixed, substantially parallel bar.

29. The abacus of claim 21 comprising 6 bars, where
18 beads are mounted on, and independently moveable along the axis of, the first of the 6 affixed, substantially parallel bars;
18 beads are mounted on, and independently moveable along the axis of, the second of the 6 affixed, substantially parallel bars;
18 beads are mounted on, and independently moveable along the axis of, the third of the 6 affixed, substantially parallel bars;
18 beads are mounted on, and independently moveable along the axis of, the fourth of the 6 affixed, substantially parallel bars;
18 beads are mounted on, and independently moveable along the axis of, the fifth of the 6 affixed, substantially parallel bar; and
18 beads are mounted on, and independently moveable along the axis of, the sixth of the 6 affixed, substantially parallel bar.

30. The abacus of claim 21 consisting essentially of:
(a) the frame;
(b) from 2 through 9 bars with one end of each of the bars being affixed to one end of the frame, the other end of each of the bars being affixed to the opposing end of the frame, and with each of the affixed bars being substantially parallel to each other; and
(c) 18 beads mounted on, and independently moveable along the axis of, each of the affixed, substantially parallel bars.

31. The abacus of claim 21 consisting essentially of:
(a) the frame;
(b) from 2 through 6 bars with one end of each of the bars being affixed to one end of the frame, the other end of each of the bars being affixed to the opposing end of the frame, and with each of the affixed bars being substantially parallel to each other; and
(c) 18 beads mounted on, and independently moveable along the axis of, each of the affixed, substantially parallel bars.

32. The abacus of claim 21 consisting essentially of:
(a) the frame;
(b) 3 bars with one end of each of the bars being affixed to one end of the frame, the other end of each of the bars being affixed to the opposing end of the frame, and with each of the affixed bars being substantially parallel to each other; and
(c) 18 beads mounted on, and independently moveable along the axis of, each of the affixed, substantially parallel bars, where
18 beads are mounted on, and independently moveable along the axis of, first of the 3 affixed, substantially parallel bars;
18 beads are mounted on, and independently moveable along the axis of, the second of the 3 affixed, substantially parallel bars; and
18 beads are mounted and independently moveable along the axis of the third of the 3 affixed, substantially parallel bars.
